(19) United States
(12) Patent Application Publication
(10) Pub. No.: US 2026/0140491 A1
(43) Pub. Date: May 21, 2026

(54) INDEPENDENT MOVER ANALYSIS SYSTEMS AND METHODS

(71) Applicant: ROCKWELL AUTOMATION TECHNOLOGIES, INC., Mayfield Heights, OH (US)

(72) Inventors: Yuhong Huang, Mayfield Heights, OH (US); Meiling He, Mayfield Heights, OH (US); Francisco Maturana, Mayfield Heights, OH (US)

(73) Assignee: ROCKWELL AUTOMATION TECHNOLOGIES, INC., Mayfield Heights, OH (US)

(21) Appl. No.: 18/950,440

(22) Filed: Nov. 18, 2024

(51) Int. Cl. G05B 19/4065

(52) U.S. Cl. CPC G05B 19/4065; G05B 2219/40068

(57) ABSTRACT

Systems, methods, and apparatuses of mover (or other track-based or autonomous mover component) parameter determination are provided. The system can determine a scaling factor based on a first plurality of input parameters. The system can generate an offset based on a second plurality of input parameters. The system can determine, based on the scaling factor and the offset input into a machine learning model trained on a plurality of input parameters that include at least one of the first plurality of input parameters and at least one of the second plurality of input parameters, a state of health. The system can map the state of health to a mover of a plurality of movers configured to travel along a track. The system can output an indication of the state of health mapped to the mover to display by a computing device.

### BACKGROUND

Autonomous vehicles can move between various locations to carry out tasks.

### SUMMARY

At least one aspect is directed to system. The system can include one or more processors, coupled with memory. The one or more processors can be configured (e.g., via instructions or data stored in memory and accessed and executed by the one or more processors) to determine a scaling factor. The scaling factor can be based on a first plurality of input parameters. The one or more processors can be configured to generate an offset. The offset can be based on a second plurality of input parameters. The one or more processors can be configured determine, based on the scaling factor and the offset input into a machine learning model trained on a plurality of input parameters that include at least one of the first plurality of input parameters and at least one of the second plurality of input parameters, a state of health. The one or more processors can be configured to map the state of health to a mover of a plurality of movers configured to travel along a track. The one or more processors can be configured to output an indication of the state of health mapped to the mover to display by a computing device.

At least one aspect is directed to a method. The method can include determining, by one or more processors coupled with memory, a scaling factor. The scaling factor can be based on a first plurality of input parameters. The method can include generating, by one or more processors, an offset. The offset can be based on a second plurality of input parameters. The method can include determining, by one or more processors, based on the scaling factor and the offset input into a machine learning (ML) model trained on a plurality of input parameters that include at one of the first plurality of input parameters and at least one of the second plurality of input parameters, a state of health. The method can include mapping, by one or more processors, the state of health to a mover of a plurality of movers configured to travel along a track. The method can include outputting, by one or more processors, an indication of the state of health mapped to the mover to be display a computing device.

At least one aspect is directed to system. The system can include one or more processors, coupled with memory. The one or more processors can be configured (e.g., via instructions or data stored in memory and accessed and executed by the one or more processors) to determine a scaling factor. The scaling factor can be based on a first plurality of input parameters. The one or more processors can be configured to generate an offset. The offset can be based on a second plurality of input parameters. The one or more processors can be configured determine, based on the scaling factor and the offset input into a machine learning model trained on a plurality of input parameters that include at least one of the first plurality of input parameters and at least one of the second plurality of input parameters, a state of health. The one or more processors can be configured to map the state of health to a component of a track-based mover system. The one or more processors can be configured to output an indication of the state of health mapped to the track-based mover system to display by a computing device.

This summary is illustrative and not intended to be limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The accompanying drawings are not intended to be drawn to scale. Like reference numbers and designations in the various drawings indicate like elements. For purposes of clarity, not every component can be labeled in every drawing. In the drawings:

FIG. 1 depicts an example system of mover parameter determination.

FIG. 2. depicts an example system of mover parameter determination.

FIG. 3. depicts an example method of mover parameter determination.

FIG. 4 depicts an example schematic block diagram of a computing system.

### DETAILED DESCRIPTION

Before turning to the figures, which illustrate certain exemplary embodiments in detail, it should be understood that the present disclosure is not limited to the details or methodology set forth in the description or illustrated in the figures. The terminology used herein is for the purpose of description only and should not be regarded as limiting.

A track can be setup in a manufacturing or transportation or other facility where movers can carry loads from point A to point B. The movers can be configured with different methods of traveling along a track such as gliding and rolling contacts that include wearable moving parts such as plastic and rubber. These movers can be configured to travel along the track to deliver loads of goods, materials, and other items. These movers can carry payloads of various weights, moving around tracks at different speeds, traveling around tracks of different configurations, and operating in different operating environments. Therefore, even with the measured mileage of a mover, the mover's remaining life can differ from one to another. These different configurations and factors make it difficult to trace the state of health of a mover.

To inspect a mover's remaining health can be an arduous task. Removing a mover from the track for inspection requires halting the entire system costing time and money. This downtime disrupts operations and delays production schedules, making it impractical to frequently inspect movers. If a mover reaches its end of life while still in use and is not removed promptly, it can cause disruptions, leading to unexpected production interruptions and potential system deterioration. This wear-related aging can compromise the integrity of the track, increase maintenance demands, and can halt operations entirely while repairs are made.

To overcome these and other challenges, the technical solutions of the present disclosure implement advanced features such as determining a scaling factor and offset based on input parameters. By employing machine learning models trained on the scaling factors and offset, the system can determine the state of health of the movers and map the state of health to the movers (or other components). By displaying the state of health mapped to a mover to a computing device, the system enables track users to understand the state of health of all the movers, optimizing track operations, production schedules and enhancing track operations.

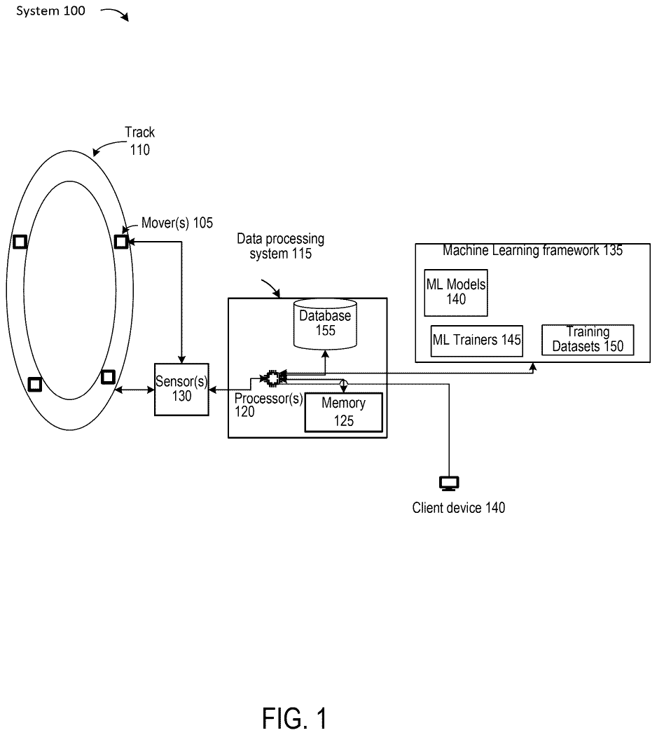

FIG. 1 depicts an example system 100 of mover parameter determination. For example, the system 100 can include an independent cart or autonomous mobile robot technology that can move at least one mover 105 around at least one track 110.

The system 100 can include one or more processors 120 coupled with memory 125. Processor 120 can include any combination of hardware and software for processing instructions, such as instructions for providing functionalities of the data processing system 115 or data, such as the data of sensor 130, Machine learning framework 135, track 110, mover 105, database 155, memory 125 or client device 140. For example, the processor 120 can receive input data or instructions from a client device 140. The processors 120 can include a processor located in the mover motor. The processors 120 can be located in a programmable logic controller (PLC), a high-level controller (HLC) or a mover 105's controller. The processors 120 can include mobile Processors, server Processors, embedded Processors (such as microcontrollers), multi-core Processors (including both single-core and multi-core variants), high-performance Processors, ARM Processors, x86 Processors, quantum Processors, FPGA-based Processors, graphics processing units (GPUs), digital signal processors (DSPs), artificial intelligence (AI) processors (such as neural processing units (NPUs) and tensor processing units (TPUs)), superscalar Processors, 64-bit Processors, hyper-threaded Processors, system-on-chip (SoC) Processors.

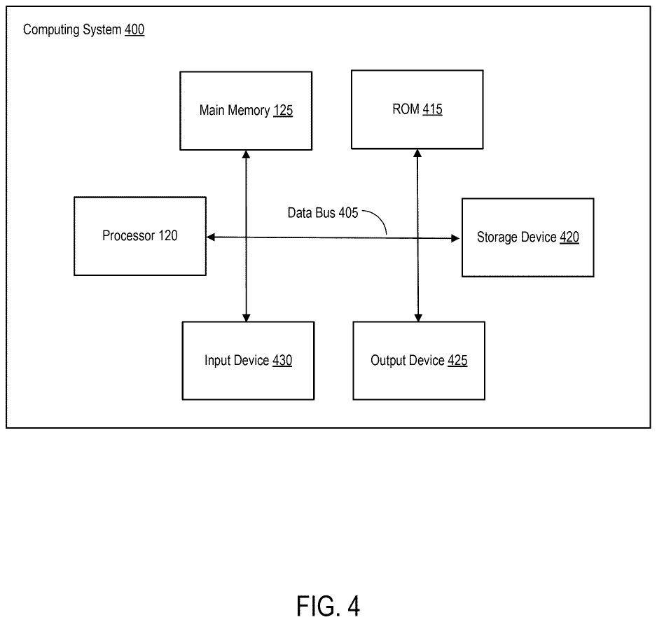

For example, at least one data processing system 115 can include one or more processor(s) 120 coupled with memory 125. The memory 125 can include RAM or ROM. The data processing system 115 can be located in a programmable logic controller (PLC), a high-level controller (HLC) or a mover 105's controller. The processors 120 can provide memory to storage device 420 (e.g., of FIG. 4 among others) or retrieve memory story to determine parameters of mover 105. For example, the mover 105 can include an independent cart technology (ICT)-based mover, conveyor-based mover, automated guided vehicles (AGV), autonomous mobile robots, linear motor movers, automated guided vehicles (AGV) using linear synchronous motor (LSM) technology, or independent cart technology (ICT)-based mover using linear synchronous motor (LSM) technology. The mover 105 can include gliding or rolling contact with track 110. The mover 105 can travel around a track 110. The mover 105 can independently move around the track. The mover 105 can move bidirectionally around the track. The movers 105 can communicate with other movers 105. Multiple movers 105 can be present and in motion on the track 110 concurrently, travelling to and from the same or different origins or destinations. The mover 105 can be programmed to be autonomous. The movers 105 can include motors. The mover 105 can include a hall effect sensor. The mover 105 can include sensor 130. The mover 105 can magnetically glide across a track 110. The movers can be configured to roll across a track 110. The mover 105 can have a unique id assigned to it. The data processing system 115 can trace the unique id of mover 105. The mover 105 can include a Near Field Communication chip, a Bluetooth chip, a Bluetooth low energy chip, a radio frequency identification (RFID) chip, a Wi-fi chip, or a cellular chip. The data processing system 115 can use a camera to identify and track the mover 105. The data processing system 115. The data processing system 115 can measure the magnetic signature of mover 105 to identify and track the mover 105.

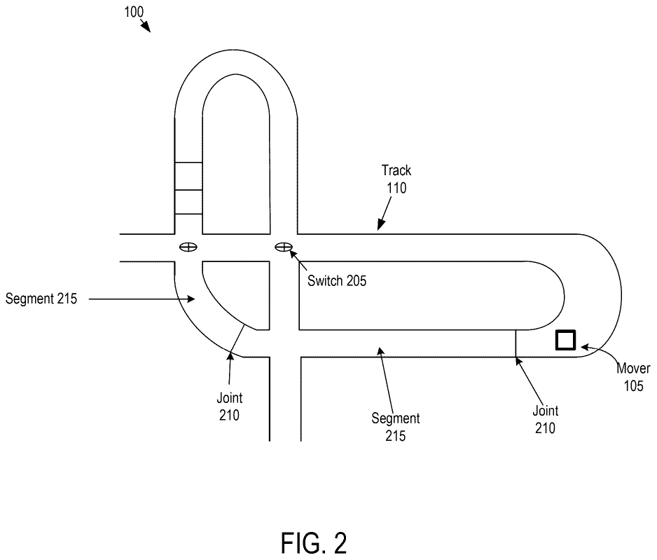

The system 100 can include at least one track 110. The track 110 can include one or more movers 105. For example, the track 110 can include a conveyance system, a pathway dedicated for a mover 105, a structure consisting of a pair of parallel lines of rails, a dedicated pathway. The track 110 can include raised walls, barriers along the edge of the pathway, or intersections with other parts of a track 110. The track 110 can include a central runner to guide the mover along the track, a smooth surface, magnetic rails, or a magnetic surface. The track can include a switch 205, a joint 210, or a segment 215 (e.g., of FIG. 2 among others).

The system 100 (e.g. data processing system 115 components such as the processor(s) 120) can determine at least one scaling factor, which can be based on input parameters, for example. The first plurality of input parameters can include at least one velocity parameter, an acceleration parameter, a deceleration parameter, a vibration parameter, a curve section parameter, a weight parameter, operation temperature parameter, operating environment parameter (e.g., in air or under water), a payload parameter, a track mileage parameter, a duty cycles parameter, a mileage parameter, or a track 110 geometry parameter. The velocity parameter can include a velocity of between 2 and 20 meters per second, (e.g., 10 m/s) as well as other velocities less than or greater than this range. The weight parameter can be between 0.5 and 500 lbs. as well as other weights greater or less than this range. The operation temperature parameter can include 150 degrees Fahrenheit. The processor 120 can take the first plurality of input parameters, assign weights to the first plurality of input parameters, add the first plurality of input parameters together, and determine the scaling factor based the first plurality of input parameters. The scaling factor can be a number that will affect the state of health. The processor 120 can receive the first plurality of input parameters from memory 125, client device 140, machine learning framework 135, sensors 130, or be provided directly to the processor 120.

Components of the system 100 such as the data processing system 115 that includes the processor 120, memory 125, and database 155 can generate at least one offset, the offset can be based on a plurality of input parameters. For example, the offset can be based on a second plurality of offset of input parameters The second plurality of input parameters can include a bearing construction parameter, a gap parameter, a bearing condition parameter, a track segment parameter, a section joint parameter, a rail joint parameter, a joint 210 parameter, a segment 215 parameter, a boundary parameter between segments 215, a switch 205 parameter, an expansion joint parameter, a flexible joint parameter, a bearing parameter (e.g., of FIG. 2 among others). The processor 120 can take the second plurality of input parameters, assign weights to the second plurality of input parameters, add the second plurality of input parameters together, and determine the offset based the second plurality of input parameters. The processor can receive the second plurality of input parameters from memory 125, client device 140, machine learning framework 135, sensors 130, or be provided directly to the processor 120.

The first plurality of input parameters can be based on historical data. can include data obtained in a controlled testing condition. The second plurality of input parameters can be based on historical data. Historical data can include data obtained in a controlled testing condition. Historical data can include total mileage or total wear of mover 105. For example, by comparing the level of the mover wear 105 after 1000 km with no load vs. a specified load, the data processing system 115 can calculate the scaling factor for that payload. For example, by measuring the additional wear of the mover 105 after 10,000 repeated track joint crossings, the data processing system 115 can derive the offset values for the type of joint 210 (e.g., of FIG. 2 among others).

For example, a machine learning (ML) model 140 can allow multiple factors to be included in a single test. In a simulated life test, the data processing system 115 can run the movers 105 with various payloads on a test track with known topology under specified move commands. The mover 105 wears are periodically measured. The differences between the actual wear and predicted wear using the parameters from the ML model 140 are used to train the ML model 140 through back propagation.

The data processing system 115 can execute space automation or optimization software. The space automation or optimization software can be located in the memory 125 or the database 155. For example, the data processing system 115 can execute the space automation or optimization software script(s) to generate a virtual version of the track 110 (e.g. a digital twin). The data processing system 115 can configure the track system or the track layout for uniform wear of the track 110.

For example, the data processing system 115 components can generate a virtual version of the movers 105 that can travel around the track 110 (e.g. a digital twin). The software can configure the number of the movers 105 on the track 110 so that the mover's 105 mileage on the track 110 can be within 10 percent of other movers 105 on the same track 110. The data processing system 115 can configure the number of the movers 105 on the track 110 to increase the throughput of the movers 105. The data processing system 115 can configure the number of the movers 105 on the track 110 so that the state of the health of the movers 105 on the track 110 are within 10 percent of each other. The data processing system 115 can create a state of health output based on simulations ran on the virtual track with virtual movers. In these and other examples the scaling factor and offset can be determined by the data processing system 115 components based on simulated or virtual first plurality of input parameters and simulated or virtual second plurality of input parameters, and the state of health can be determined for a simulated or virtual mover of a plurality of simulated or virtual movers.

For example, the system 100 can update at least one first input parameter and the second input parameter based on a change in the first input parameter or the second input parameter. For example, the system 100 can detect a change in either the first input parameter or the second input parameter based on data received from a sensor 130. The system can detect a change in either the first input parameter or the second input parameter based on input received from a processor 120. Sensor 130 can be located on track 110, in mover 105, or outside track 110. Sensor 130 can provide data to processor 120. Sensor 130 can capture data that can be processed to be a first input parameter or a second input parameter. The system 100 can determine a change in either the first input parameter or the second input parameter based on data received from the memory 125 or be provided directly to the processor 120.

For example, the system 100 can determine at least one state of health of mover 105. For example, the system 100 can determine a state of health based on the scaling factor and the offset input into a machine learning model 140 trained on a plurality of input parameters that include at least one of the first plurality of input parameters and at least one of the second plurality of input parameters. For example, the system 100 can determine a state of health based on the scaling factor and the offset input into a machine learning (ML) model 140 trained on a plurality of input parameters that include at least one of the first plurality of input parameters, at least one of the second plurality of input parameters and a measured mileage parameter. The system 100 can determine a state of health based on the scaling factor and the offset input. The system 100 can also determine a state of health based on the scaling factor, the offset input and a measured mileage parameter. The system 100 can provide a score based on the scaling factor and the offset input to the ML model 140 to cause the ML model 140 to generate a state of health of the mover 105. The system 100 can generate a state of health by combining the scaling factor and the offset. The system 100 can generate a state of health by combining the scaling factor and the offset and multiplying it with the measured mileage of the mover 105. The state of health can be affected by the scaling factor. The state of heath can be affected by the offset. The state of health can be affected by the measured mileage of the mover 105. The state of health can include a status that indicates the mover will malfunction after 10 more hours of runtime. The state of health can be indicated as the true mileage of a mover 105. For example, the system 100 can determine, based on the output generated by the MLmodel, that a mover has 5% of its life remaining.

The system 100 can update at least one state of health of mover 105. For example, the system 100 can determine a state of health based on the scaling factor and the offset input into a machine learning model (ML) 140 trained on a plurality of input parameters that include at least one of the first plurality of input parameters and at least one of the second plurality of input parameters. The system 100 can generate a state of health by combining the scaling factor and the offset of the mover 105. The system 100 can generate a state of health by combining the scaling factor and the offset and multiplying it with the measured mileage of the mover 105. The system 100 can update the mover 105's state of health by assigning a mover 105 a unique identifier and assigning the mover 105's unique identifier a new state of health.

The system 100 can update at least one machine learning (ML) model 140. For example, the ML model 140 can be updated using data from the database 155 or memory 125. The ML model 140 can be updated with data on different track 110 configurations, different mover 105 models, or different operating environments. The ML model 140 can be updated with different ML models such as object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM).

The system 100 can determine at least one configuration for the mover 105. For example, the system 100 can determine a configuration for the movers 105, based on the first plurality of input parameters and the second plurality of input parameters inputted into the machine learning (ML) model 140 trained on a plurality of data from the mover 105. The data can include positional data of the mover 105, state of health data of the mover 105, weight data of the mover 105, velocity data of the mover 105, acceleration data of the mover 105, the data of the track 110 that mover 105 is configured to be on, vibration data of the mover 105, operating temperature data of the mover 105, mileage data of the mover 105. The system 100 can provide the mover 105 data based on the movement of the mover 105 to the ML model 140 to cause the ML model 140 to generate a mover 105 configuration on the track 110.

For example, the system 100 can output at least one a mover 105 configuration where movers 105 are further apart than the previous configuration to reduce collision occurrences or the movers 105 decrease their previously configured speed to facilitate better mover to mover communication. For example, the system 100 can output a mover 105 configuration can that movers 105 be configured to be closer with respect to a previous configuration together to increase efficiency. For example, the system 100 can output a mover 105 configuration where the movers 105 decrease their payload relative to a previous configuration to increase the mover 105's lifespan.

Machine learning (ML) framework 135 can include any combination of hardware and software for providing or utilizing machine learning functionalities associated with the technical solutions described herein. ML framework 135 can include, for example, any combination of one or more supervised or unsupervised ML or artificial intelligence (AI) models 140, including, for example, deep learning models, reinforcement learning model, ensemble models, decision tree models, linear models, non-linear models, generative models, discriminative models or embedding models. ML framework 135 can include one or more ML trainers 145 for training, configuring or otherwise managing ML models 140 using one or more training datasets 150, which can include various data for labeled or unlabeled, supervised, or unsupervised training of ML models 140.

For example, ML framework 135 can include various AI or ML features, such as AI environments that can provide an open-source library for developing ML applications, such as Tensorflow. For example, ML framework 135 can include various AI or ML features, such as entity detection using a variety of sensors such as radar sensors, and lidar sensors. For example, ML framework 135 can include various AI or ML features, such as adaptive learning using reinforcement models.

ML framework 135 can include any ML models 140, which can include one or more of: neural networks, decision-making models, linear regression models, natural language models, random forests, classification models, generative AI models, reinforcement learning models, clustering models, neighbor models, decision trees, probabilistic models, classifier models, or any other type and form of models. ML models 140, can include, for example, models include natural language processing (e.g., support vector machine (SVM), Bag of Words, Counter Vector, Word2Vec, k-nearest neighbors (KNN) classification, long short erm memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others.

The Machine learning (ML) framework 135 can include ML models 140 such as generative AI models, which can include any machine learning systems configured to create new content, such as text, images, or audio, by learning patterns from the database 155. The ML models 140 can be trained using techniques, such as supervised learning, unsupervised learning, and reinforcement learning. The ML models 140 can utilize data set from database 155 to create logical inferences between various complex structures in the data set to generate data for the ML models 140.

ML models 140 can include any machine learning (ML) or artificial intelligence (AI) model designed to generate content or new content, such as text, images, or code, by learning patterns and structures from existing data. ML models 140 can be any model, a computational system or an algorithm that can learn patterns from data (e.g., chunks of data from various input documents, computer code, templates, forms, etc.) and make predictions or perform tasks without being explicitly programmed to perform such tasks. ML models 140 can refer to or include a large language model (LLM). The Machine learning (ML) framework 135 can be trained using a dataset of data (e.g., text, images, videos, audio, or other data). ML models 140 can be designed to understand and extract information from the dataset. ML models 140 can leverage image processing techniques and pattern recognition to comprehend the context and meaning of data it is being fed.

ML models 140 can be trained using deep learning techniques, such as neural networks that are trained on large amounts of data (e.g., training datasets 150 of images, videos, or sensor data). ML models 140 can be designed, constructed, or include a transformer architecture with one or more of a self-attention mechanism (e.g., allowing the model to weigh the importance of different tokens, embeddings or values when encoding a sensor data, image or a video frame), positional encoding, encoder and decoder (multiple layers containing multi-head self-attention mechanisms and feedforward neural networks). For example, each layer in the encoder and decoder can include a fully connected feed-forward network, applied independently to each position. The data processing system 115 can apply layer normalization to the output of the attention and feed-forward sub-layers to stabilize and improve the speed with which the ML model 140 is trained. The data processing system 115 can leverage any residual connections to facilitate preserving gradients during backpropagation, thereby aiding in the training of the deep networks. Transformer architecture can include, for example, a generative pre-trained transformer, a bidirectional encoder representation from transformers, transformer-XL (e.g., using recurrence to capture longer-term dependencies beyond a fixed-length context window), text-to-text transfer transformer, image-to-image transformer or similar.

The ML models 140 can be trained (e.g., by a model training function) using any combination of one or more object-based, and environmental condition-based dataset by converting the data from the input dataset into numerical representations (e.g., embeddings) of the chunks of the data. These embeddings can capture the semantic meaning of sensor values, image or video clips, words, paragraphs, pages or sentences, depending on the size and type of chunks being parsed. Embeddings can be used to represent and organize the dataset within a high-dimensional space (e.g., embedding space), where similar concepts are located closer together. Embedding space can include a multi-dimensional vector space where each data point is represented by an embedding. The ML model 140 can be trained to determine a state of health for a mover 105. The ML model 140 can be trained to determine a state of health for a component of a track-based mover system. The ML model 140 can be trained on a plurality of input parameters that include at least one of the first plurality of input parameters and at least one of the second plurality of input parameters. The ML model can be trained on a plurality of the mover 105 data.

The ML model can be trained on historical track data of one or more track 110 configurations. For example, the ML model can train on track 110 configuration data provided by memory 125, database 155 or directly from the processor. Track 110 configurations can include tracks that have been previously configured and saved, 3D maps of tracks, track data captured by sensor 130. Track 110 configurations can include tracks that have been used before.

The ML model can be retrained on historical track data of one or more track 110 configurations. For example, the ML model 140 can be trained on a plurality of input parameters that include at least one of the first plurality of input parameters and at least one of the second plurality of input parameters and a measured mileage parameter. The ML model 140 can be retrained based on measurements of a track 110 and a mover 105 obtained from routine maintenance. The ML model 140 can be retrained using supervised learning techniques.

The ML model 140 can be pretrained on historical track data of one or more track 110 configurations. For example, the ML model 140 can be pretrained based on measurement data obtained under controlled test conditions. For example, historical track can include prior track configurations.

Through training, by a ML trainer 145, the ML model 140 can learn, or adjust its understanding of mapping the embeddings to particular issues (e.g., speed measurements, weight measurements or videos of movers on a track), by adjusting its internal parameters. Internal parameters can include numerical values of the ML model 140 that the model learns and adjusts during training to optimize its performance and make more accurate predictions. Such training by the ML trainer 145 can include iteratively presenting the various data chunks or documents of the dataset (e.g., or their chunks, embeddings) to the ML model 140, comparing its predictions with the known correct answers, and updating the model's parameters to minimize the prediction errors. By learning from the embeddings of the dataset data chunks, the ML model 140 can gain the ability to generalize its knowledge and make accurate predictions or provide relevant insights when presented with prompts.

The ML models 140 can include any ML or AI model or a system that can learn from a dataset to generate new content (e.g., timings, schedules, direction and velocities, or images) that resembles a distribution of the training dataset. A distribution of a dataset can include an underlying probability distribution representing the patterns and characteristics of the data used to train an ML model. 140. For example, a training data distribution can represent statistical properties of an image, video, or sensor data, such as the frequency of movers or their locations, weight, acceleration, or velocities, the configuration of the track 110, and the overall structure of the data used in the training dataset. The ML model 140 can include the functionality to utilize such a probability distribution of patterns and characteristics to generate new responses (e.g., predictions) that were not present in the dataset.

The system 100 can map the state of health to at least one mover 105 of a plurality of movers configured to travel along a track. For example, the system 100 can map the state of health to a component of a track-based mover system. The system 100 can map the state of health by tracking the unique identifier of the mover 105 by using sensors 130 and assigning the unique identifier a score indicating a state of health. The sensor 130 can track the movers 105 unique identifier by detecting a radio wave, a Bluetooth signal, a Wi-Fi signal, a Near Field Communication signal, or an RFID signal emitting from a mover 105 or a track 110. Sensor 130 can track the mover 105 unique identifier by scanning the QR or bar code of the mover 105. Sensor 130 can track a mover 105 by using a camera to identify and track the mover 105. The data processing system 115 can track a mover 105 by measuring the magnetic signature of mover 105 to identify the mover 105. The unique identifier can be stored in database 155, or memory 125.

The system 100 can output at least one indication of the state of health mapped to the mover 105 to display by a computing device. For example, the computing device can be a client device 140. The client device can include or utilize, for example, an output device, such as, output device 425 of FIG. 4. Client device 140 can include a computing device, a monitor, a server, a mobile device, a television, a Human-Machine Interface (HMI) panel. The state of health indication can be outputted as a score. The score could be from 0-10, 0-100, a percentage. The state of health could be displayed as a mileage figure labeled as true mileage. The state of health could be displayed as an indication of how much more the time the mover 105 can run before it reaches an end of life condition.

The system 100 can update at least one indication of the state of health mapped to the mover 105 to display by a computing device. For example, the system 100 can update the state of health directly from the processor, from memory 125, or from database 155.

For example, database 155 can include any combination of hardware and software for storing data or information. Database 155 can include or utilize, for example, a storage device, such as, storage device 420 of FIG. 4. Database 155 can include, for example, various data structures for storing and relating various types and form of data utilized by the system 100. Database 155 can include and store, for example, data on movers 105, data on track 110, as well as data from sensors 104. The database 155 can be part of the memory 125 or separate from the memory 125.

For example, sensor 130 can include any combination of hardware and software for sensing or measuring data used by the example system 100. For example, sensor 130 can include devices, systems, components, or circuits for capturing or measuring signals indicative of presence, state, velocity, or any other characteristics of a mover 105. Sensor 130 can include any combination of sensors or detector for capturing various analog or digital data. For example, sensor 130 can include radar sensors for measuring mover speed and distance, and lidar sensors for creating 3D maps of track 110 or detecting mover 105 shapes and distances. Sensor 130 can include ultrasonic sensors configured for detection of movers at various distances from the sensors. Sensor 130 can include infrared sensors to detect thermal signatures of mover 105 or track 110. Sensor 130 can include doppler radar sensors to measure mover speeds, or piezoelectric sensors on track 110 to detect weight and pressure from movers 105. Sensors 130 can include optical or fiber optic sensors for monitoring mover 105 movement, velocity, or direction, as well as stress and strain on track surfaces. Sensor 130 can include laser rangefinders to measure track distances and mover 105 positions. Sensor 130 can include vibration sensors to detect mover 105 movement on track 110, as well as accelerometers to measure the acceleration, deceleration, speed, and orientation of movers 105. Sensor 130 can include water detection sensors to detect presence of water. Sensor 130 can include gas sensors to detect gases (e.g., oxygen, carbon dioxide, methane). Sensor 130 can include barometric pressure sensors to measure atmospheric pressure. Sensor 130 can include a Near Field Communication sensor, a barcode scanner, a quick response (QR) code scanner, a Bluetooth chip, a Bluetooth sensor, a Bluetooth low energy sensor, a radio frequency identification (RFID) sensor, a Wi-fi sensor, or a cellular sensor to track the mover 105. Sensor 130 can include Hall effect sensors to detect magnetic fields. Sensor 130 can be located in the mover 105. The sensor 130 can be located in a programmable logic controller (PLC), a high-level controller (HLC) or a mover 105's controller. The sensor 130 can be located on track 110.

FIG. 2 depicts an example of system 100 of mover parameter determination. For example, the system 100 can include an independent cart technology that is configured to move at least one mover 105 around at least one track 110. The track 110 can include a segment 215, a joint 210, or a switch 205.

The joint 210 can include any connection point between sections of the track 110. Joint 210 can include at least one butt joint, an interlocking joint, a flexible joint, an expansion joint, a sliding joint, a slip joint, a magnetic joint, conductive joint, ball-and-socket joint, or damped joint.

The switch 205 can include any mechanism that enables movers to change from one track path to another. For example, switch 205 can include at least one magnetic switch, a turnout switch, a gate switch, a cross-over switch, a sliding rail switch, an automated switch that can detect mover 105 with sensors 103 (e.g., of FIG. 1 among others), a slip switch, spring switch, fan-shaped curved switch, or rotary switch.

The segment 215 can include any distinct section of track 110 that provides a pathway for the mover 105 within the track 110. For example, segment 215 can include a straight rail segment, a curved rail segment, an angled segment, turn rail segment, a cross-over rail segment, an inclined rail, declined rail segment, a flexible rail segment, a switch rail segment, a magnetic rail segment, a stopper rail segment, a buffer rail segment, a power-embedded rail segment, a sensor-integrated rail segment, an articulated rail segment, or modular rail segment

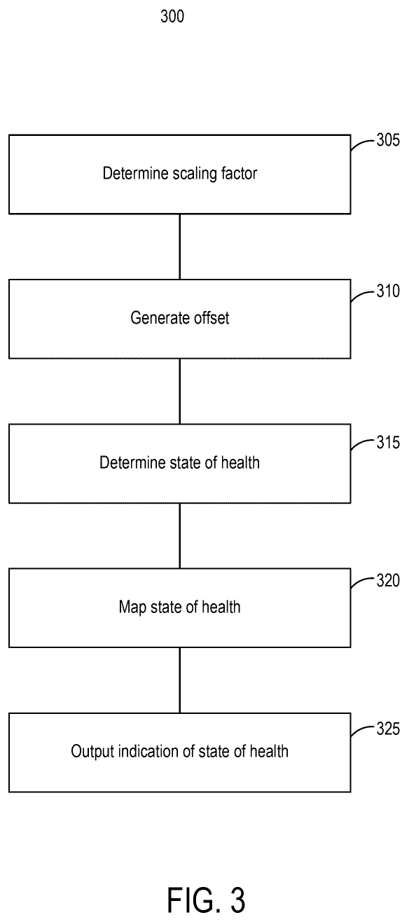

FIG. 3 depicts a method 300 of mover parameter determination. The method can include acts 305-325. At ACT 305, the method can include determining a scaling factor. At ACT 310, the method can include generating an offset. At ACT 315, the method can include determining a state of health. At ACT 320, the method can include mapping a state of health. At ACT 325, the method can include outputting an indication of the state of health.

The method 300 can include determining a scaling factor (ACT 305). For example, the one or more processors can determine a scaling factor based on a first plurality of input parameters.

The method 300 can include generating an offset (ACT 310). For example, the one or more processors can generate an offset based on a second plurality of input parameters.

The method 300 can include determining a state of health (ACT 315). For example, the one or more processors can determine a state of health based on the scaling factor and the offset input into a machine learning model trained on a plurality of input parameters that include at least one of the first plurality of input parameters and at least one of the second plurality of input parameters.

The method 300 can include mapping a state of health (ACT 320). For example, the one or more processors can map a state of health to a mover of a plurality of movers configured to travel along a track.

The method 300 can include outputting an indication of a state of health (ACT 325). For example, the one or more processors can output an indication of the state of health mapped to the mover to display by a computing device.

FIG. 4 illustrates a block diagram of an example computing system 400, also referred to as a computer system 400 or a computing device 400. The computing system 400 can include, included by, or be used to implement a data processing system 115. The computing system 400 includes at least one bus 405 or other communication component for communicating information and at least one processor 120 or processing circuit coupled to the bus 405 for processing information. The computing system 400 can also include one or more processors 120 or processing circuits coupled to the bus for processing information. The computing system 400 also includes at least one main memory 125, such as a random-access memory (RAM) or other dynamic storage device, coupled to the bus 405 for storing information, and instructions to be executed by the processor 120. The main memory 125 can be used for storing information during execution of instructions by the processor 120. The computing system 400 may further include at least one read only memory (ROM) 415 or other static storage device coupled to the bus 405 for storing static information and instructions for the processor 120. A storage device 420, such as a solid-state device, magnetic disk or optical disk, can be coupled to the bus 405 to persistently store information and instructions.

The computing system 400 may be coupled via the bus 405 to a client device 140, such as a liquid crystal display, or active-matrix display, for displaying information to a user. An input device 430, such as a keyboard or voice interface may be coupled to the bus 405 for communicating information and commands to the processor 120. The input device 430 can include a touch screen display. The input device 430 can also include a cursor control, such as a mouse, a trackball, or cursor direction keys, for communicating direction information and command selections to the processor 120 and for controlling cursor movement on the output device 335, such as a display.

The processes, systems and methods described herein can be implemented by the computing system 400 in response to the processor 120 executing an arrangement of instructions contained in main memory 125. Such instructions can be read into main memory 125 from another computer-readable medium, such as the storage device 420. Execution of the arrangement of instructions contained in main memory 125 causes the computing system 400 to perform the illustrative processes described herein. One or more processors in a multi-processing arrangement may also be employed to execute the instructions contained in main memory 125. Hard-wired circuitry can be used in place of or in combination with software instructions together with the systems and methods described herein. Systems and methods described herein are not limited to any specific combination of hardware circuitry and software.

What is claimed is:

1. A system of mover parameter determination, comprising:
one or more processors, coupled with memory, to:
determine a scaling factor based on a first plurality of input parameters;
generate an offset based on a second plurality of input parameters;
determine, based on the scaling factor and the offset input into a machine learning model (ML) trained on a plurality of input parameters that include at least one of the first plurality of input parameters and at least one of the second plurality of input parameters, a state of health;
map the state of health to a mover of a plurality of movers configured to travel along a track; and
output an indication of the state of health mapped to the mover to display by a computing device.

2. The system of claim 1, comprising:
the first plurality of input parameters including at least one of a velocity parameter, an acceleration parameter, a deceleration parameter, a curve section parameter, or a weight parameter; and
the second plurality of input parameters including at least one of a gap parameter, a switch parameter, a boundary parameter between track segments, or a rail joint parameter.

3. The system of claim 1, comprising the one or more processors to:
update, based on the first parameters and the second parameters inputted into a machine learning (ML) model trained on a plurality of data from the mover, the state of health of the mover.

4. The system of claim 1, comprising the one or more processors to:
update the first input parameter and second input parameter based on a change in the first input parameter or second input parameter.

5. The system of claim 1, comprising the one or more processors to:
update the indication of health mapped to the mover to display by a computing device.

6. The system of claim 1, comprising the one or more processors to:
update the machine learning (ML) model.

7. The system of claim 1, comprising the one or more processors to:
determine, based on the first plurality of input parameters and the second plurality of input parameters inputted into the machine learning (ML) model trained on a plurality of data from the mover, a mover configuration.

8. The system of claim 1, comprising the one or more processors to:
determine, based on the first plurality of input parameters and the second plurality of input parameters inputted into the machine learning (ML) model trained on a plurality of data from the mover, a track configuration.

9. The system of claim 1, comprising the one or more processors to:
train the machine learning (ML) model on historical track data of one or more track configurations.

10. The system of claim 1, comprising the one or more processors to:
retrain one or more ML models using data from one or more prior track configurations to improve determinations of state of health.

11. The system of claim 1, comprising the one or more processors to:
determine, based on the scaling factor, the offset and a measured mileage parameter input into a machine learning (ML) model trained on a plurality of input parameters that include at one of the first plurality of input parameters, at least one of the second plurality of input parameters and a measured mileage parameter, a state of health.

12. A method, comprising:
determining, by one or more processors coupled with memory, based on a first plurality of input parameters, a scaling factor;
generating, by one or more processors, based on a second plurality of input parameters, an offset;
determining, by one or more processors, based on the scaling factor and the offset input into a machine learning (ML) model trained on a plurality of input parameters that include at one of the first plurality of input parameters and at least one of the second plurality of input parameters, a state of health;
mapping, by one or more processors, the state of health to a mover of a plurality of movers configured to travel along a track; and
outputting, by one or more processors, an indication of the state of health mapped to the mover to be display a computing device.

13. The method of claim 12, wherein the first plurality of input parameters includes at least one of: a velocity parameter, an acceleration parameter, a deceleration parameter, a curve section parameter, or a weight parameter; and
the second parameter of input parameters includes at least one of: the second plurality of input parameters including at least one of a gap parameter, a switch parameter, a boundary parameter between track segments, or a rail joint parameter.

14. The method of claim 12, comprising:
updating, by one or more processors, based on the first parameters and the second parameters inputted into a machine learning (ML) model trained on a plurality of data from the mover, the state of health of the mover.

15. The method of claim 12, comprising:
updating, by one or more processors, the first input parameter and second input parameter upon a detection of a change in the first input parameters or second input parameter.

16. The method of claim 12, comprising:
updating, by one or more processors, the indication of health mapped to the mover to display by a computing device.

17. The method of claim 12, comprising:
updating, by one or more processors, the machine learning (ML) model.

18. The method of claim 12, comprising:
determining, by one or more processors, based on the first plurality of input parameters and the second plurality of input parameters inputted into a machine learning (ML) model trained on a plurality of data from the mover, a mover configuration.

19. The method of claim 12, comprising:
determining, by one or more processors, based on the first plurality of input parameters and the second plurality of input parameters inputted into a machine learning (ML) model trained on a plurality of data from the mover, a track configuration.

20. A system of track-based parameter determination, comprising:
one or more processors, coupled with memory, to:
determine a scaling factor based on a first plurality of input parameters;
generate an offset based on a second plurality of input parameters;
determine, based on the scaling factor and the offset, a state of health;
map the state of health to a component of a track-based mover system; and
output an indication of the state of health mapped to the track-based mover system to display by a computing device.
